(19) United States
(12) Patent Application Publication
(10) Pub. No.: US 2020/0320151 A1
(43) Pub. Date: Oct. 8, 2020

(54) System and Method of Generating Destination Recommendations Based on Smart Destination Scoring Methodology

(71) Applicant: Lawrence Philips, Lithonia, GA (US)

(72) Inventor: Lawrence Philips, Lithonia, GA (US)

(21) Appl. No.: 16/739,112

(22) Filed: Jan. 9, 2020

Related U.S. Application Data
(60) Provisional application No. 62/790,416, filed on Jan. 9, 2019.

(51) Int. Cl. G06F 16/9535; G06F 16/9536

(52) U.S. Cl. CPC G06F 16/9535; G06F 16/9536

(57) ABSTRACT

Disclosed are various embodiments of generating recommendations for particular destinations in a predefined global area. A user submitted query associated with city characteristics required for a destination in an electronic repository is received, each of the destinations being associated with user generated city scores, reviews, and destination content. Scores relevant to the user submitted query are identified. Destinations relevant to the user submitted query are displayed with a weighted scoring element based on city characteristics selected and user profile information. The destination recommendation engine will use destination metadata in comparison to user profile parameters to determine relevance of the destination to user query based on weighted scoring (Smart Score) history and logistic regression modeling. User submitted queries are stored in query data store and are aggregated based on frequency threshold and user profile parameters to recommend most relevant search queries to user. Destination relevance to the user submitted queries and destination query recommendations are determined based at least upon one destination and query being relevant. Upon identification of destinations that meet the criteria of the user, booking option will be me available.

### CLAIM OF PRIORITY

This application claims priority of the U.S. Provisional Patent Application No. 62/790,416, filed on Jan. 9, 2019, the contents of which are fully incorporated herein by reference.

### FIELD OF THE INVENTION

The present invention relates to a system and method of responding with travel recommendations where responses are adjusted in accordance to factors most relevant or important to the requester.

### BACKGROUND OF THE INVENTION

The internet has long become a virtual encyclopedia of information relating to travel. Initially only the cool and glamorous locations were getting all the coverage, while plenty of decent and respectable getaways were languishing in relative obscurity, not getting the appropriate coverage because they were not sufficiently remote or exotic. The lack of coverage was then offset by professional writers of travel books, who wrote about every corner of the globe. However, an obvious problem with such synthetically processed information was that the writer's personal preferences would always leach through what was supposed to an unbiased review. At times it was becoming too easy to identify the real sponsor of information, which would completely undermine the entire integrity of the work.

The internet writers have largely taken over from the traditional book writers, as the old style was simply unable to keep up with the updates. But information from bloggers and posters was mostly unreliable. It was difficult to distinguish between sponsored content and organic posts. Since posting on the web was so easy, too many people were posting inferior material, which, for some time, significantly diminished quality of information. To overcome this shortcoming, informational websites, and indeed the majority of internet sites, began to solicit feedback from users and visitors. The downside of this feedback is that reviews are most often presented sequentially rather by relevance. Even when relevance is considered, relevance score is usually arbitrary or from a narrow subset of attributes which are not correlated to interests of a particular user.

Another shortcoming of the present state of the art is that relevance factors were identified and displayed by the computer programs and data querying routines. These programs generally have a monolithic approach to query results, that are based on the provided criteria in the search, without consideration of what would actually be important to the requester besides the requester's search routine. focused on unique criteria of a dataset without determining whether the criteria would be equally important to the requester.

To solve this problem the present disclosure presents a solution which is a computer enabled system to which accepts user specified search routine and provides a response to such routine, sorting results based on user's preferences and personal biases to zero in on highly relevant and accurate travel recommendations. The results are grouped by a plurality of attributes, whose weight is adjusted based on the inquirer's personal profile and preferences of the requester.

### SUMMARY OF THE INVENTION

The various embodiments of content delivery system described herein relate to generating travel recommendations to a user who may be seeking advice regarding a particular destination, where the destinations are stored in and/or retrieved from an electronic repository. It should be appreciated that destinations in the electronic repository may be associated with destination reviews and scores that are authored by various users. Additionally, the various embodiments described herein can also relate to generating destination recommendations for a user.

As a non-limiting example, some consumers plan their trip without a clear idea of a particular destination or a destination that appeals to them. Many will have very obscure geographic sense of where they would like to go, but would not know specific merits or attractions of a particular location. Rather, a user may only know that he or she is seeking a vacation of a particular style (i.e. Relaxation, Adventurous, etc), or those that may cater to a certain subset of users, such as family oriented, or particularly well suited or ill-suited for certain races, ethnicities or sexual orientations, all of which may be attributes from which to choose.

As another non-limiting example, a user may know that they are seeking to vacation in a particular Historic region. While this is a specific destination criteria they chose because of the type of the trip that was desired to be experienced, specific information and scoring of how good the offering of History is compared to other destination is not provided, nor are other parts considered, irrespective of how important they may be, for example, how good the food is or if the destination is friendly to women, travelers of color or those displaying affiliation with certain social or religious group. Additionally, in the above non-limiting example, the user may have some knowledge of a specific destination but is seeking additional advice from those who consider themselves a Luxury or Budget Travelers because those travel traits are most in line with their own.

Existing content delivery systems often allows users to write and/or publish reviews of particular activities and eateries in a specific destination about which they may have knowledge. However, they do not provide an opportunity to give an overall travel score of that destination nor to complete reviews that span various overall city characteristics (i.e. Adventure, Nightlife, Relaxation etc.). For example, a user may have traveled to a particular destination and experienced a particular activity like shark diving. Accordingly, a user may author a review of their specific experience that can be published within a third-party content delivery system or elsewhere. However, the ability is not given to author a review of the entire destination experience in relation to Adventure, to mention other adventurous activities (i.e. riding an ostrich), and to elaborate further on additional higher-level city characteristics (i.e. Nightlife, Romance). Accordingly, reviews cannot be filtered by characteristics and traits of other travelers that are most in line with users (i.e. seeing only reviews from users that are a History-Buff or an Adventure-Seeker). While a user may wish to determine an ideal destination to vacation to meet specific travel needs, reviews may be too specific that it does provide the overall offering and view of the destination, reviews submitted by users who may possess knowledge of the destination may be polarized, skewing to be extremely positive or negative, the reviews may include travelers that do not have a similar travel styles to the user performing the query and so the actual needs of the user may not be addressed.

Accordingly, various embodiments of the disclosure can provide destinations suggestions to users seeking advice on locating a particular destination by receiving a user submitted query corresponding to the desires of a user in choosing destinations. The user submitted query can be associated with a particular region of the World (e.g., Europe) from which a user is seeking to vacation, and may include desired city characteristics such as Romance, Relaxation, and Local Food to be scored highly which may not be included in the published, specific reviews available from third-party content delivery systems. Accordingly, embodiments of the disclosure can locate reviews submitted by other users concerning destinations within the specific region and city characteristics that may be relevant to the user submitted query. Additionally, the reviews and scores identified by query can be further filtered to align to particular travel behavior traits and styles (i.e. rest and relaxation, luxury traveler, hotels being preferred accommodations) that are in line with user and those that are not in line can be removed. Locations identified by destination recommendation engine based on user input criteria will provide digital and downloadable travel content from database in an organizational structure mirroring the available city characteristics identified in user search query. In this way, the travel content delivery system can leverage a corpus of reviews to provide destination recommendations and travel content to a user that are specific to the user submitted query and that is extracted from reviews and scores submitted by other users that are relevant.

### BRIEF DESCRIPTION OF THE DRAWINGS

FIG. 1 illustrates method for generation destination recommendations and query. recommendation based on user reviews, scores, and profile parameters.

FIG. 2 illustrates a network environment in which recommendation engines based on user submitted queries and related profile parameters operate.

FIG. 3 illustrates exemplary components of the destination recommendation search system.

FIG. 4 illustrates exemplary components of the query recommendation search system.

FIG. 5. Illustrates destination scores and city characteristics based on SMART Score weighted attribute elements.

FIG. 6 illustrates reviews organized by city characteristics.

FIG. 7 illustrates travel map and travel statistics linked to a user's profile.

FIG. 8 illustrates destination content organized by city characteristics and scoring segments.

FIGS. 9A-9E provide sample equations for determining weighted query smart scores.

FIG. 10. Illustrates mobile and desktop profile and destination filter module.

FIG. 11 demonstrates the overall layout of the disclosed system.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

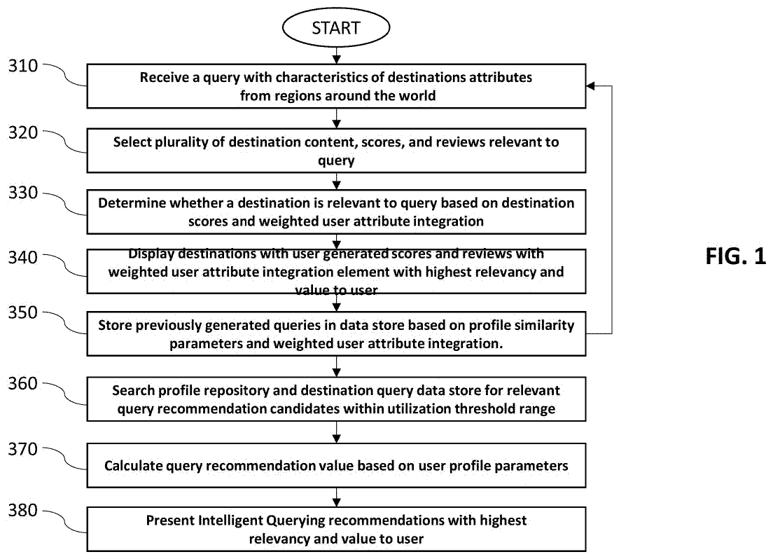

FIG. 1 describes the steps generally taken in enabling the disclosed method. In the initial step 310 the process begins with receiving a query containing characteristics of a desired destination from around the world. These characteristics may be the desired or preferred features explored by a user, such as family friendly spots, party spots, things to see and places to stay. It may also include less common attributes, such as compatibility or favorability of certain travel destinations with respect to race, ethnicity or sexual orientation.

Step 320 then compares attributes marked as important in the query with plurality of destination data results sharing similar factors, who are relevant to or matching to the factors asked in the query. Once a data set has been identified in step 320, it is further refined using the weighted user attribute integration in step 330, which interprets facts in the assembled dataset through the prism of attributes important with querying user.

The next step 350 of displaying the results in step 340 displays the dataset assembled by the computer system, including the full glory and grading of the accompanying reviews. However, the importance of certain comments and ratings are diminished while the magnitude of others are increased, all depending on the weighted user attribute for the given query. As an additional feature, the weighted user attribute result subset is stored for ease of access to benefit users with similar whether user attributes and to gauge responses to future inquiries by the same users. Another importance of step 350 is to address an inaccurate or imperfect response of queries, which prompts users to submit follow-up inquiries. Stored or cached subsets that were presented previously, and which already received the weighted user attribute modification, are joined with subsequent resulting datasets to produce a more refined or consistent list of results.

The results identified by user and system as matching the weighted user attribute are then stored in step 360 to provide future query recommendation within the same or similar threshold range. The step is also used to search profile repository and destination query datastore for relevant query commendation candidates within utilization threshold range.

In an effort to zero in on the precise response in line with the weighted user attribute, the system calculates query recommendation value based on user profile parameters in step 370 and finally present again, or initially, depending on user settings,

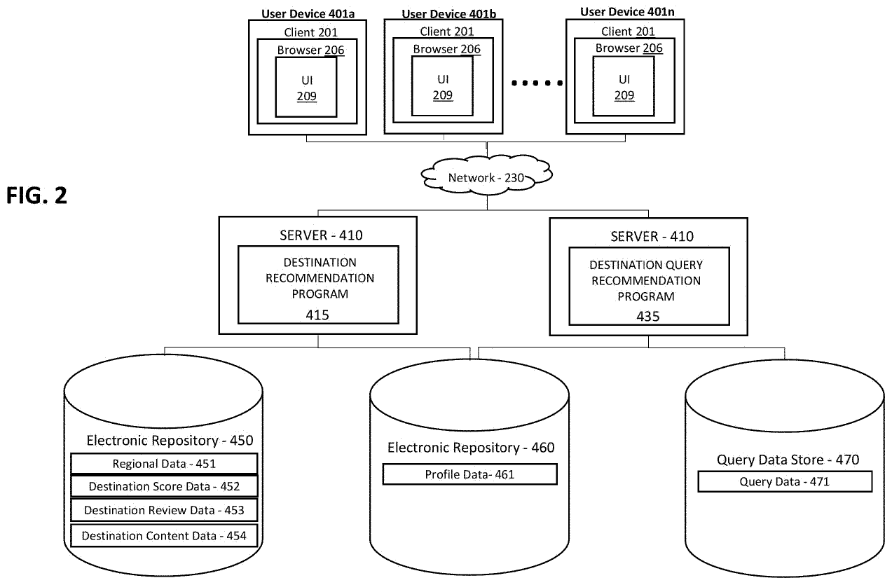

FIG. 2, shows a networked environment 400 in which a recommendation system operates based on destination reviews 415 and destination queries 435. The destination recommendation system 415 and query recommendation system 435 can interact with one or one or more user devices 401, destination electronic repositories 450, profile parameter electronic repositories 460 and query data store 470. The depicted user interface 209 can be rendered by a browser 206 executing in a customer client 201 in the networked environment 400 according to various embodiments of the present disclosure.

The destination recommendation system 415 and query recommendation system 435 may be configured to provide a user with destination recommendations and query information by utilizing the user's profile parameters and expected city characteristic score inputted by user. The destination recommendation system 415 and query recommendation system 435 may comprise one or more processors, such as a server farm, a cloud-computing platform, a parallel computer, and so on, and storage devices. The destination recommendation system 415 and query recommendation system 435 may interact with destination electronic repositories 450, profile parameter electronic repositories 460 and query data store 470 to collect or retrieve relevant information. Relevant information may include the destination data, profile parameters and the like.

User devices 401, such as a user device 401 a, user device 401 b, and user device 401 n, may be any devices associated with one or more users, such as a cellular telephone, a personal digital assistant (PDAs), a tablet, a desktop or a laptop computer, a wearable device, or any other devices including computing functionality and data communication capabilities. The user devices 401 may be configured to enable the user to receive or post destination score, and display destination reviews and travel content. The user devices 401 may interact with the destination recommendation system 415 and query recommendation system 435 by requesting and obtaining the aforementioned data via the network 230.

In some embodiments, users may utilize the user devices 401 to interact with the destination recommendation system 415 and query recommendation system 435 by way of one or more software applications (i.e., client software) running on and/or accessed by the user devices 401, wherein the user devices 401 and the destination recommendation system 415 and query recommendation system 435 may form a client-server relationship. For example, the user devices 401 may run dedicated mobile review applications associated with the destination recommendation system 415 and query recommendation system 435 and/or utilize one or more browser applications to access destination reviews (e.g., webpages) associated with the destination recommendation system 415 and query recommendation system 435. In turn, the destination recommendation system 415 and query recommendation system 435 may deliver information and content to the user devices 401 related to the user input criteria, for example, by way of one or more destinations (e.g., web pages or pages/views of a mobile application).

In some embodiments, the client software (i.e., software applications installed on the user devices 401) may be available as downloadable mobile applications for various types of mobile devices. Alternatively, the client software can be implemented in a combination of one or more programming languages and markup languages for execution by various web browsers. For example, the client software can be executed in web browsers that support JavaScript and HTML rendering. The various embodiments of client software applications may be compiled for various devices, across multiple platforms, and may be optimized for their respective native platforms.

The database associated with destination electronic repository 450 may be associated with the regional data, destination score/reviews, and travel content. The number of databases or types of databases may be altered, and two or more types of databases may be combined to form a single type of database. The user database with profile data may be configured to store the user's profile information. The user profile information may also include any connections between similar profile attributes of the destination recommendation system 415 and query recommendation system 435. The destination query database 470 may be configured to store information related to a destination query.

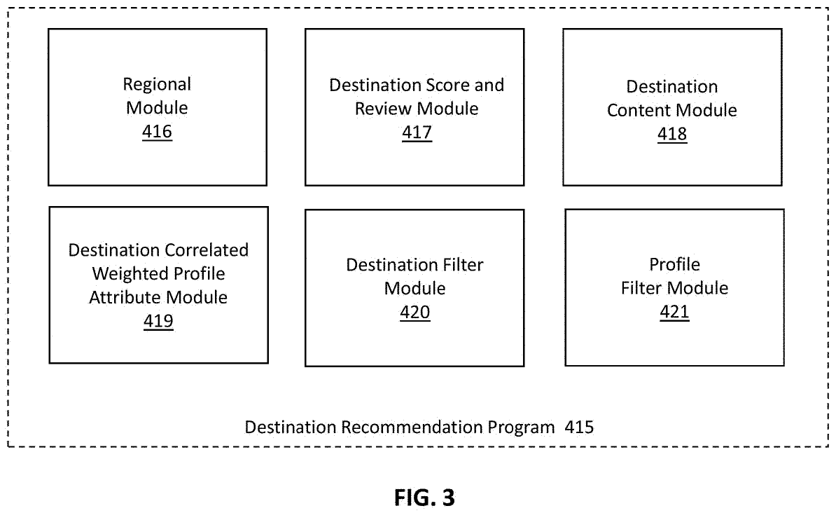

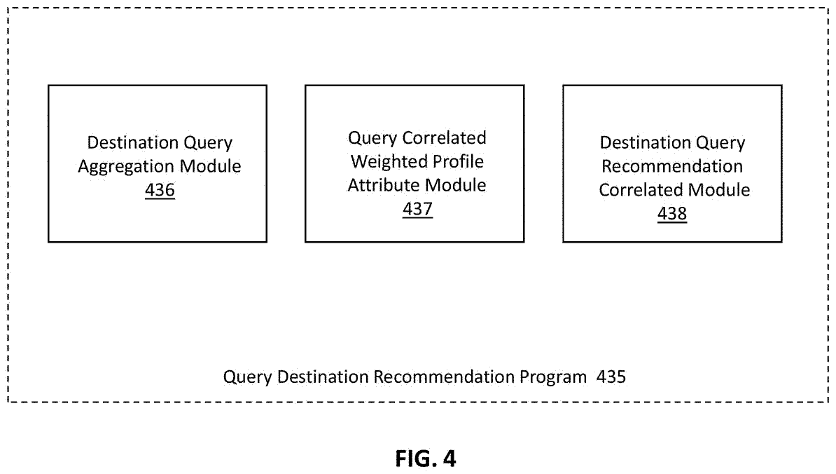

FIG. 3 demonstrates the preferred components that make up the destination recommendation system 415. The listed modules may be further segmented into smaller modules or the listed modules may be combined into more complex modules. The destination recommendation program 415 and the destination query recommendation program 435 make up the bulk of the server process 410. Shown in FIG. 3 is the regional module 416, the destination scores and review module 417, the destination content module 418, the destination correlated weighted profile attribute module 419, the destination filter module 420 and profile and a profile filter module 421.

The query destination recommendation program 435 may be further split into several submodules, namely, the destination query aggregation module 436, the query correlated weighted profile attribute module 437 and the destination query recommendation correlated module 438. As with destination recommendation program 415, the disclosed components of the destination recommendation program 435 may be further split or assembled into simpler or more complex modules. The modules themselves may be written in any computer language, such as Java, C # or using .Net protocols. Additional scripting may be implementing to record and display individual user profiles and preferences. The server process 410 may additionally be embedded with an application server process, such as Websphere®, Jboss or WebLogic®.

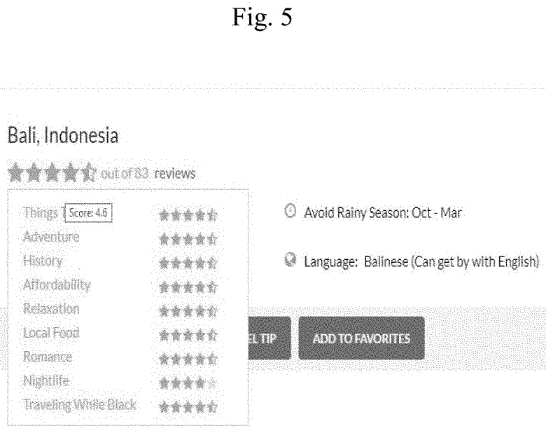

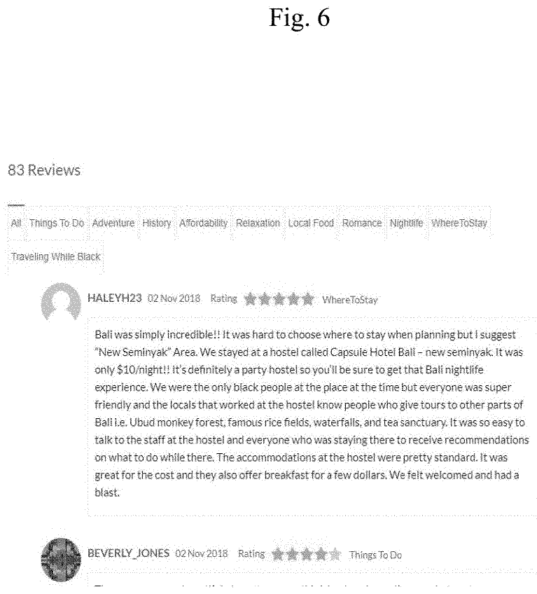

FIG. 5 provides some examples of characteristics Illustrates destination scores and city characteristics based on SMART Score weighted attribute elements instrumented through the regional module 416. The user submitted query can be associated with a destination's region in which a user is seeking advice and/or recommendations related to the query. Destination content module 418 reviews/scores stored in the destination electronic repository 450 will be linked to a regional hierarchy that include corresponding country and region of the world. One example of such chart is provided in FIG. 5. Destination results will be filtered based on regional inputs provided by user submitted query. Those regions are subject but not limited to continents and geographical areas outlined below:
North America
South America
Asia
Africa
Europe
Oceania
Antarctica
Caribbean
Central America
Middle East

Each destination score left by a user will be associated with a review outlining prior experiences and recommendations based on a user's previous visit to that destination and stored in the destination electronic repository 450. Each review will be linked to a specific city characteristic (i.e. Adventure, Relaxation) and will be displayed on the corresponding city listing page by that city characteristic. Each city listing page will have a dedication section for those reviews and corresponding scores left by the user to be displayed.

Reviews and scores left by users will be stored in user's profile page. For each city reviewed, the corresponding country is maintained in a custom travel map in a user's profile page that outlines the amount of countries visited by the user. The reviews and score data are stored in a destination electronic repository 450 and profile electronic repository 460. The countries experienced by the user will impact the confidence rating and the weight attribute element to overall country and city characteristic scoring outlined by Destination Correlated Weighted Profile Attribute Module 419.

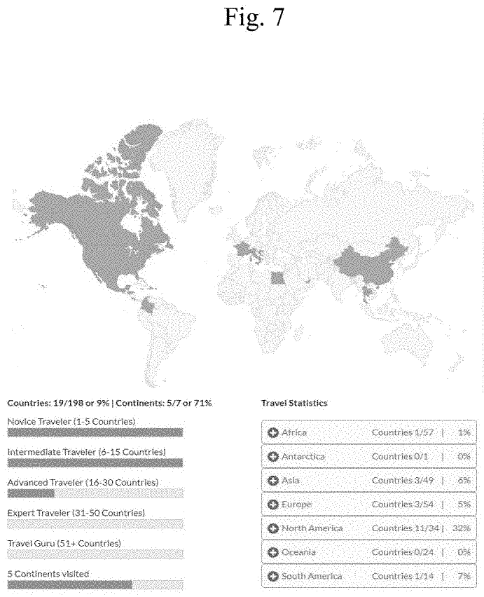

Destination Content Module 418 shown in FIG. 7 processes downloadable or digitally related travel destination guides, making them available upon the rendering of a city a listing page. Downloadable content will be in the form of PDF's. Digitally available content will have content organized by tabs. These guides will be structure by the same city characteristics and regions outlined by the Destination Score and Review Module 417 and the Regional Module of the specific city listing page 416.

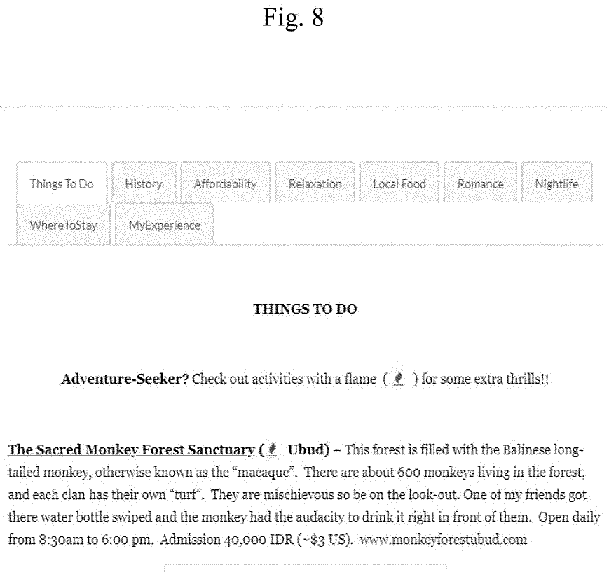

As shown in FIG. 8, each rank score left by a user and recorded by the application will be normalized to have relevant impacts to overall score of destination as well as to the score of the specific city characteristics scores of each destination based on a confidence rating of the user. This will be calculated based on the travel experience of user which will be identified by the System. The score left by a user for a specific destination, will be stored systematically in the destination data repository and stored in the profile electronic repository. The destination score data stored in the profile electronic repository will be rendered as a components in digital geographic map to the user. For every destination added to the digital geographic map, an additional factor of experience is added to the user which will be incorporated into the confidence rating of the user as weighted attribute element in the scoring routine executed by System. The weighted attribute element will alter the standard scoring process by using a weighted arithmetic mean across overall destination scoring for all geographical regions stored in the System based on the Travel Confidence Rating Group the System determines a user is allocated and their corresponding weighted attribute coefficient.

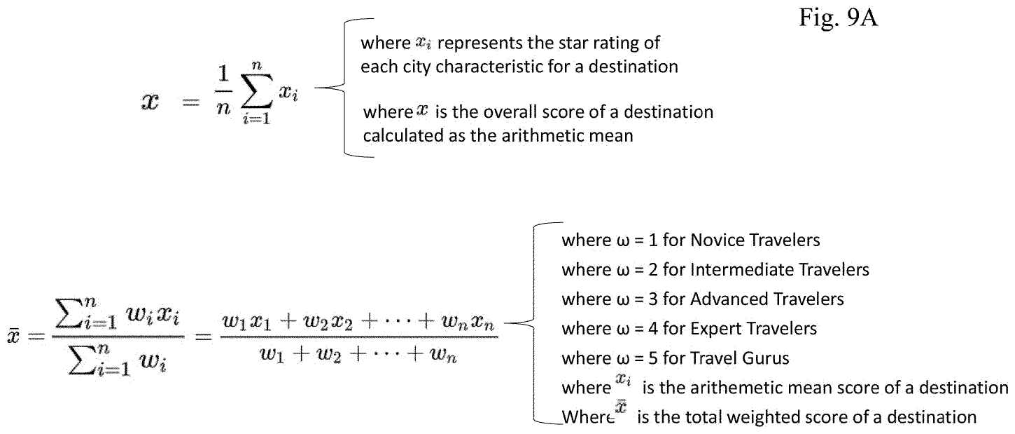

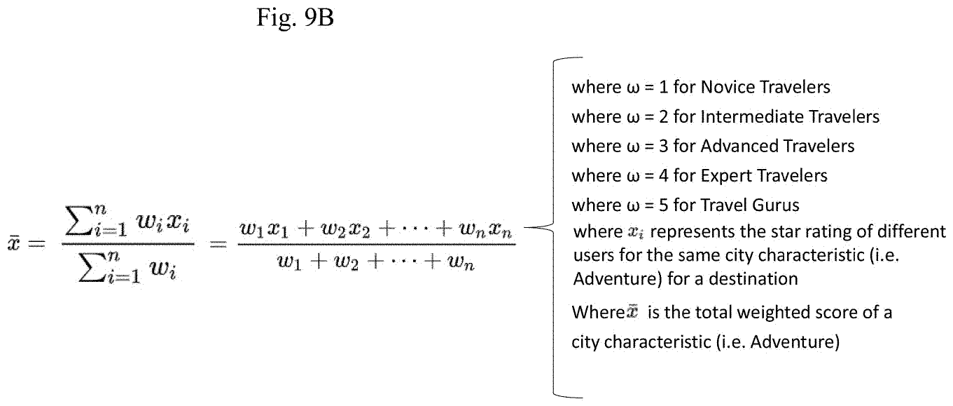

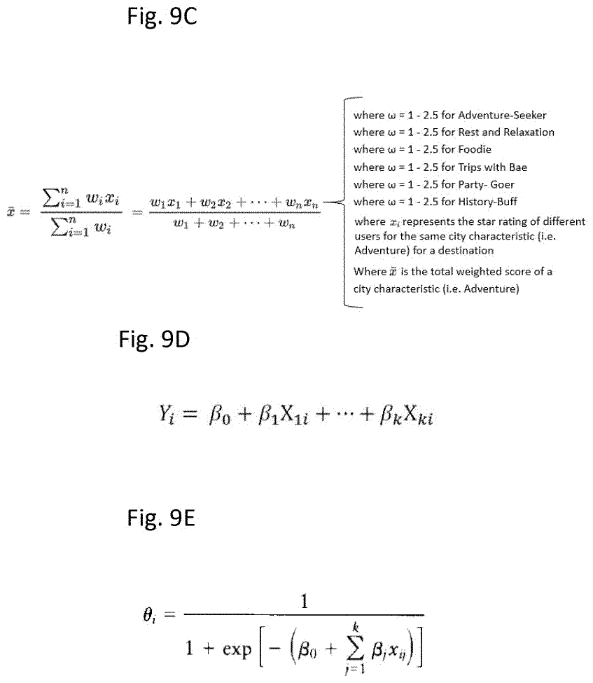

Destination Correlated Weighted Attribute Module 419 handles the Confidence Rating Attribute—Overall Destination Score. Each score left by a user will be normalized to have relevant impacts to overall score of destination as well as to the score of the specific city characteristics scores of each destination based on a confidence rating of the user. This will be calculated based on the travel experience of user which will be identified by the System. The score left by a user for a specific destination, will be stored systematically in the destination data repository and stored in the profile electronic repository. The destination score data stored in the profile electronic repository will be rendered as a component in digital geographic map to the user. For every destination added to the digital geographic map, an additional factor of experience is added to the user which will be incorporated into the confidence rating of the user as weighted attribute element in the scoring routine executed by System. The weighted attribute element will alter the standard scoring process by using a weighted arithmetic mean across overall destination scoring for all geographical regions stored in the System based on Travel Confidence Rating Group the System determines a user is allocated as illustrated by the probability formulas provided in FIG. 9A.

Confidence Rating Attribute—City Characteristic Score, calculation shown in FIG. 9B; Each score left by a user will be normalized to have relevant impacts to city characteristics scores of each destination (i.e New York's Adventure Rating) based on a confidence rating of the user. This will be calculated based on the travel experience of user which will be identified by the System. The weighted attribute element will alter the standard scoring process by using a weighted arithmetic mean across city characteristic scoring for all geographical regions stored in the System based on Travel Confidence Rating Group the System determines a user is allocated. Each city characteristics calculation will be executed independently and aggregated to create overall all weighted attribute score for destination.

Profile Parameter Attribute—City Characteristic Score by Behavior Traits shown in FIG. 9C: Each destination score left by a user will be normalized to have relevant impacts to overall score of destination as well as to the score of the specific city characteristics scores of each destination based on a profile parameter relevance to the specific scoring attribute. User's will populate a profile and identify specific travel behavioral traits and styles that they are most aligned. The system will identify these parameters and store in profile electronics repository and execute a comparatives logistic regression analyses to determine appropriate weights for each city characteristics to allocate for a user. The weighted attribute coefficient for the profile parameter weight attribute would consistently be a value of 1 in a standard calculation. However, additional weights can be given to users that have self-identified to be a specific travel style. With this approach, when a user is scoring a city's related city characteristic based on their profile attribute (i.e. an Adventure Seeker is rating Adventure) their scoring weight will be able to range from a value of 1 to an increase weight of up to 2.5. The appropriate profile weighted attribute allocation for each coefficient will be based on a logistic regression model of the travel categorical selections made by users with each comment (B1) and the predetermined city relevance to travel styles that a user has visited (B2) based on the formula shown in 9D. As a binary logistic model, the indicator variable will be a 1, a user is of a particular travel style, and 0 a user is not of that specific travel style.

For each travel style (i.e. Adventure-Seeker, History-Buff etc) identified by a user in their profile, a specific coefficient of B1/B2 and will be identified. The B1/B2 coefficient will be an input in determining the likelihood that user actual is of the travel-style that they self-identified based on the regression model executed. The more instances of comments relating to travel style selected and countries visited relevant the travel style the higher the probability (see FIG. 9E).

The probability of a user to be of the specific travel that was self-selected in their profile will be programmatically determined. That probability will be scaled to be within the range of 1-2.5, the lower the probability the lower the weight, the higher the probability, the higher the weight. All weights for each user for each travel style will be aggregated and averaged to determine an overall weight that will be allocated for the travel style group for when a user of that travel style group rates a related city characteristic value for a particular city. Using the logistic regression calculated weights for each user who identified to be a specific travel style, the following formula will be used. One of the parameters must be met for system to allocate weight.

Confidence Rating and Profile Parameter Attributed Attribute Combined:

It is important for scoring methodology to not be a general reorganization of data but to have logic and rules in place that will be uniquely relevant based on mathematical computations and weights to allow scores to be more accurate and relatable to users. In addition, how that information is filtered and returned back to the user as users search for destinations and overall destination scores and city characteristic score are being displayed on the application UI is also an important factor which is further described in 420 Destination Filter Module and 421 Profile Filter Module.

After each score is submitted, the code aggregator will identify previously submitted scores for the related destination. The System will combine the user's submitted score and incorporated the weighted attribute element based on confidence ratings and the weighted attribute element based on profile parameters and logistic regression model to create Smart Destination Score. The Smart Destination Score will be combined with previously submitted Smart Destination Scores generate a new Smart Score the destination and related city characteristics.

As an example. User's submits a score for a destination with the following Confidence Rating Attributes and Profile Parameters.

### User A=Adventure Seeker|Intermediate

### User B=No Profile Information Populated

### User C=Foodie|Trips With Bae|Expert

### User D=Party-Goer|Travel Guru

### User E=Foodie|Intermediate

The standard core score would be calculated using equal weights to each user and equal weights for each city characteristic.

| | | | | | | | | | Traveling | |
|---|---|---|---|---|---|---|---|---|---|---|
| | Things | | | Local | | | | Afford- | While | User |
| User | To Do | Adventure | Relaxation | Food | Romance | Nightlife | History | ability | Black | Score |
| User A | 5 | 5 | 1 | 4 | 5 | 5 | 3 | 4 | 5 | 4.11 |
| User B | 5 | 3 | 1 | 5 | 2 | 4 | 1 | 2 | 4 | 3.00 |
| User C | 3 | 3 | 2 | 4 | 1 | 1 | 3 | 1 | 1 | 2.22 |
| User D | 4 | 4 | 3 | 3 | 2 | 4 | 2 | 1 | 4 | 3.00 |
| User E | 3 | 4 | 3 | 4 | 2 | 5 | 2 | 1 | 4 | 3.11 |
| Standard | 4 | 3.8 | 2 | 3.4 | 2.4 | 4.6 | 2.2 | 1.8 | 3.6 | 3.09 |
| Score | | | | | | | | | | |

The confidence weighted attribute element would be executed upon each user successfully submitting a review on a specific destination listing page based on the initial standard score. Various weights would be allocated to each user's destination score and specific city characteristics score based on the confidence rating of the user. The score will impact the overall calculated score for a city and each individual score submitted by user will not be changed. The city characteristic scores will be directly impacted.

| Confidence | | | | | | | | | | |
|---|---|---|---|---|---|---|---|---|---|---|
| Weighted | | | | | | | | | Traveling | |
| Attribute | Things | | | Local | | | | Afford- | While | Weighted |
| Element | To Do | Adventure | Relaxation | Food | Romance | Nightlife | History | ability | Black | Average |
| User A | 2 | 2 | 2 | 2 | 2 | 1 | 2 | 2 | 2 | 4.11 |
| User B | 1 | 1 | 1 | 1 | 1 | 1 | 1 | 1 | 1 | 3.00 |
| User C | 4 | 4 | 4 | 4 | 4 | 4 | 4 | 4 | 4 | 2.22 |
| User D | 5 | 5 | 5 | 5 | 5 | 5 | 5 | 5 | 5 | 3.00 |
| User E | 2 | 2 | 2 | 2 | 2 | 2 | 2 | 2 | 2 | 3.11 |
| Actual | 3.79 | 3.79 | 2.29 | 2.86 | 2.14 | 4.57 | 2.36 | 1.50 | 3.29 | 2.95 |
| Weighted | | | | | | | | | | |
| Atttibute | | | | | | | | | | |
| Score | | | | | | | | | | |

The behavior weighted attribute element would be executed in series of user successfully submitting a review on a specific destination listing page based on the previously generated confidence rating score. Various weights would be allocated to each user's destination score and specific city characteristics score based on the profile parameters of the user and the logistic regression weighted attribute value calculated.

| Behavior | | | | | | | | | | |
|---|---|---|---|---|---|---|---|---|---|---|
| Weighted | | | | | | | | | Traveling | |
| Attribute | Things | | | Local | | | | Afford- | While | Weighted |
| Element | To Do | Adventure | Relaxation | Food | Romance | Nightlife | History | ability | Black | Average |
| User A | 1 | 1.4 | 1 | 1 | 1 | 1 | 1 | 1 | 1 | 4.15 |
| User B | 1 | 1 | 1 | 1 | 1 | 1 | 1 | 1 | 1 | 3.00 |
| User C | 1 | 1 | 1 | 2.2 | 1.9 | 1 | 1 | 1 | 1 | 1.99 |
| User D | 1 | 1 | 1 | 1 | 1 | 2.4 | 1 | 1 | 1 | 3.13 |
| User E | 1 | 1 | 1 | 1.5 | 1 | 1 | 1 | 1 | 1 | 3.16 |
| Actual | 4.00 | 3.89 | 2.00 | 3.01 | 2.19 | 4.47 | 2.20 | 1.80 | 3.60 | 3.05 |
| Weighted | | | | | | | | | | |
| Attribute | | | | | | | | | | |
| Score | | | | | | | | | | |

Combining the Confidence Weighted Attribute Element Scoring with Behavior Weighted Attribute Element Scoring creates Smart Score for the city and for the particular destination. The SMART Destination Score creates unique scoring approach that will be integrated with 420 Destination Filter Module and 421 Profile Filter Module.

### SMART Destination Score by User

| | |
|---|---|
| User A | 4.13 |
| User B | 3.00 |
| User C | 2.11 |
| User D | 3.07 |
| User E | 3.13 |

### SMART Destination Score by City Characteristic

| | | | | | | | | Traveling |
|---|---|---|---|---|---|---|---|---|
| Things | | | Local | | | | Afford- | While |
| To Do | Adventure | Relaxation | Food | Romance | Nightlife | History | ability | Black |
| 3.89 | 3.84 | 2.14 | 2.94 | 2.16 | 4.52 | 2.28 | 1.65 | 3.44 |

### Overall SMART Destination Score: 3.00

Users will submit a query to the system to identify destinations that meet input criteria. Destination input criteria will include geographical regions, overall destination scores, and destination city characteristics. The filter engine will identify relevant destinations in electronic repository for geographic regions based on the 416 Regional Module and destination scores and destination city characteristics based on 417 Destination Score and Review Module. The scores identified by the 420 Destination Filter Module will be based on Smart Destination Scores generated by the 419 Destination Correlated Weighted Profile Attribute Module. Destinations that are shown will also have the option to be booked by a user requesting getaway suggestions.

Profile Filter Module 421 used to process user query submissions to the system to identify destinations that meet input criteria based on filtering scores and reviews of users based on behavior traits and profile parameters. The profile filter engine will identify relevant destination scores and reviews in the destination electronic repository in series to Destination Filter Module 419 determining relevant destinations. Users will populate profile with parameters related to their travel behavior and style (i.e. Adventure-Seeker). Profile filter engine will access destination scores in destination electronic repository based on Destination SMART Scoring from 420 Destination Filter Module of the user submitted query and sequentially compare relevant destination scores in profile electronic repository to determine the appropriate linkage of profile parameters to each destination score. The profile filter engine will compare the profile parameters in user profile of the user submitting the query to profile parameters of relevant destinations returned by 420 Destination Filter Module. Only destination scores and reviews that are relevant to profile based on user submitted query will be an output of Profile Filter Engine. For example, if a user filters previously submitted reviews and scores and only wants to consider reviews left by users who consider themselves “Adventure-Seeker”, only Smart Scores left by users with those specific parameter requirements will be returned. This allows users submitted queries to return more accurate information and only consider reviews of people that travel based on similar behavior traits.

Additionally, based on profile parameters, input criteria for the profile filter module will have the ability to be defaulted to aid in the expedience of users adding input criteria to identify destinations.

The Destination Query Aggregation Module 436 uses submitted queries will be stored in the query electronic repository. As more queries are stored, the system will identify the most frequently used queries executed in the database based on a query threshold and purge queries that are not frequently executed. Queries will be aggregated based on previously described functionality of 416 Regional Module, 410 Destination Filter Module, and 421 Profile Filter Module categorization areas.

The Query Correlated Weighted Profile Attribute Module 437 steps in and for each query left by a user normalizes the results to have relevant impacts to overall query ranking. This will be calculated based on the travel experience of user which will be identified by the system. The query left will be stored systematically in the query data repository and related profile parameters of users will be stored in the profile electronic repository. Based on the 419 Destination Correlated Weighted Profile Attribute Module which determines Confidence Rating and Profile Behavior Trait rating, queries will be ranked and organized. Users that have higher confidence rating will increase the weight attributed factor of queries that meet aggregated query threshold and ranked to be shown to users on the UI. Additional, queries executed by users with specific profile parameters that meet threshold will be aggregated and ranked based on weighted attribute for city characteristics that are most relevant and be shown to Users on UI.

Destination Query Recommendation Correlated Module 438 presents queries that will be recommended to users during the usage of Destination Filter Module 420 and Profile Filter Module 421. Previously submitted query by users will be able to saved to user's profile so they can be executed on demand. Enhanced version of querying will be available to users to alter the inclusion of Destination Correlated Weighted Profile Attribute Module 419 in the destination results returned by the query. Users will have the ability to search for destination based on SMART Destination Scores, Confidence Rating Weighted Attribute Destination Scores and/or Profile Weighted Destination Attribute Scores and results will be reflected in Destination Filter Module 420 and Profile Filter Module 420. Additional queries will be recommended to users based profile attributes. The system will access query data in the query electronic repository based and determine the appropriate linkage of profile parameters to each query. The query search logic will compare the profile parameters in user profile of the user submitting the query to the queries available in query electronic repository. Only queries that are relevant to profile based on user submitted query and queries that meet threshold requirements will be a recommendation option for the user. Destinations that are shown will also have the option to be booked as destinations by researching user.

For example, if a user is searching for a destination in Europe and is identified as a History-Buff in their personal profile, the highest ranked queries including the various subcategories scoring values for users who are searching for destination in Europe that are also history buffs will be recommended to the user. The queries recommended will be based on one query being available in the query electronic repository that has met threshold requirements and contain matching profile parameters to user submitting the query.

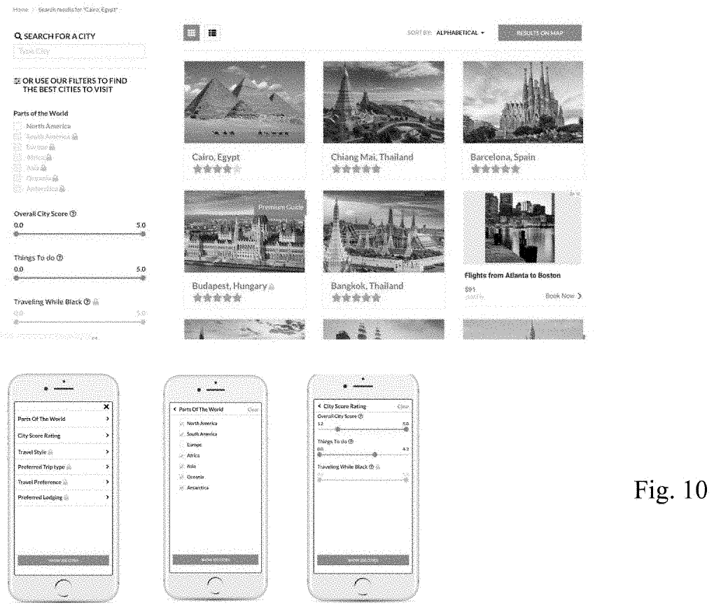

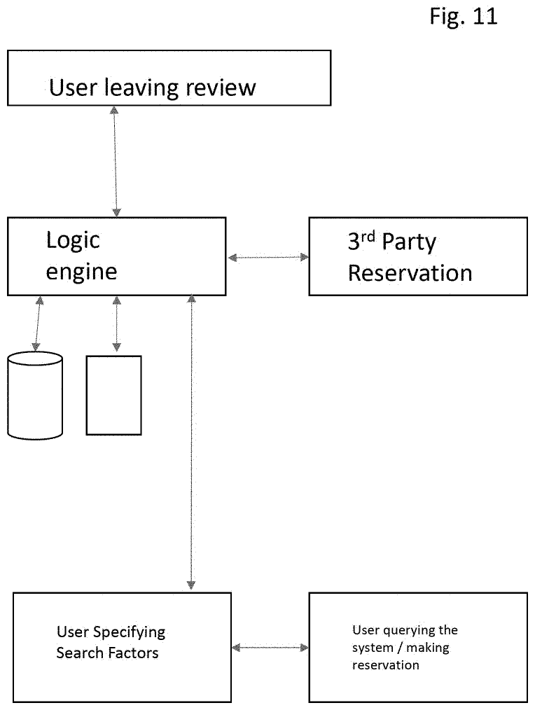

FIGS. 10 and 11 demonstrate the general screenshots and hardware layout of the disclosed application. FIG. 10 demonstrates that the application may be displayed on a personal computer or a tablet device, such as a smart phone. The disclosed application contains a front end that is preferably a website where users may leave reviews and seek destination ideas. The website will initially present a user with a series of factors that must or must not be present at a desired destination locations, such as, but not limited safety, tolerance, family friendly, peacefulness, natural beauty, history, accommodations, cuisine, cost, etc. The user will then assign a weight to each factor from most to least importance. After specifying preferences, the user will provide a query, such as, “African destination”. or “Caribbean island” the system will then produce the most ideal place that satisfies both the search query as well as the weighted importance factors sorted by weight. This function is left to the logic engine of the disclosed application, which applies the formulas disclosed in the figures. The user may reserve a vacation directly through the disclosed system by clicking on one of the destination screens, as shown in FIG. 10. The logic engine will then direct the user to an appropriate 3^{rd} party booking site, or process the reservation itself directly with provider, or through a 3^{rd} party booking site. The frontend user interface UI may run in Windows, Linux, Unix or iOS. The logic engine may be written in Java, C #, PHP, Python, Ruby or any other language and combination of languages. The system uses a database to store user information, prior queries and prior ratings and opinions of users. This database may be distributed or centralized and may run on Oracle, Db2, Sybase or MySql.

Although this invention has been described with a certain degree of particularity, it is to be understood that the present disclosure has been made only byway of illustration and that numerous changes in the details of construction and arrangement of parts may be resorted to without departing from the spirit and the scope of the invention.

What is claimed:

1. A method of generating recommendations for particular destinations in a predefined global area comprising the steps of a user submitting a query associated with attributes of a target locale desired by said user for a destination; receiving said query in an electronic repository, each of the destinations being associated with user generated scores, said scores representing a rated subset of attributes describing said locale, said rating derived from reviews by peers of said user; identifying scores relevant to the query submitted by said user; obtaining a subset of destinations relevant to the user's query, said subset displayed with a weighted scoring element based on attributes of said locale selected from said user's profile information; and using a recommendation engine to compare destination metadata to user's profile parameters to determine relevance of a destination to user's query based on said weighted scoring history.

2. The method of generating recommendations of claim 1, further comprising the step of storing said queries submitted by said user in a query data store, said queries are then aggregated based on frequency threshold and user profile parameters to recommend most relevant search queries to said user.

3. The method of generating recommendations of claim 1, further comprising the step of determining destination relevance in relation to queries submitted by said user, wherein said destination query recommendations are determined based on relevancy of said query to at least one destination.

4. A method of generating recommendations for a travel destination comprising the steps of creating a rating system, wherein aid rating system soliciting user ratings, wherein categories for said ratings being provided by said user, another user submitting a query associated with said attributes; receiving said query in an electronic repository; associating said attributes to said another user's personal profile or preferences; modifying a weight of at least one of said rating based on said personal profile or preferences; and using a recommendation engine to compare destination metadata to user's profile parameters to determine relevance of a destination to user's query based on said weighted scoring history.
